(19) United States
(12) Patent Application Publication
(10) Pub. No.: US 2018/0042244 A1
(43) Pub. Date: Feb. 15, 2018

(54) SEALED DISMOUNTABLE MOLD FOR FOOD PREPARATION

(71) Applicant: TELLIER GOBEL ET CIE, ARGENTEUIL (FR)

(72) Inventors: MALEK BARKIA, PARIS (FR); ANNE-LAURE NABAT-FLECHER, HERBLAY (FR); MORGANE BIGNON, PARIS (FR); JEAN-PAUL LESENECHAL, TAUXIGNY (FR)

(21) Appl. No.: 15/550,776

(22) PCT Filed: Jan. 22, 2016
(86) PCT No.: PCT/FR2016/050134

§ 371 Date: Aug. 12, 2017

(30) Foreign Application Priority Data
Feb. 13, 2015 (FR) 1551193

(51) Int. Cl. A21B 3/13; A47J 37/01

(52) U.S. Cl. CPC A21B 3/13; A47J 37/01

(57) ABSTRACT

A mold for food preparation, in particular for cake dough or similar, includes a semi-cylindrical rigid wall forming a trough and open at the two ends of same, and two transverse end walls, complementary to the trough, to form with the trough, a container open at the top and closed at the transverse side ends. The semi-cylindrical wall and the transverse walls are detachably associated. The mold further includes two sealer, each configured to engage one of the end edges of the trough. Each sealer is associated with a flat rigid plate to form, with the corresponding rigid plate, one of the transverse walls, and includes a peripheral groove configured to receive and engage the corresponding peripheral edge of the semi-cylindrical wall in the shape of a trough.

The present invention concerns a sealed dismountable mold for a food preparation, such as cake dough, and designed for hot cooking, especially in an oven, but also designed for freezing, especially in a freezer or else at rest in a refrigerator.

The invention shall be described more particularly with regard to a mold of oblong shape, such as a log, loaf cake or brioche mold.

Rigid metallic molds of a single piece are known. However, the release of the cake from the mold is often troublesome.

The appearance on the market of flexible silicone molds have made it possible to solve this problem of mold release. However, this type of flexible mold has the disadvantage of being hard to handle when the food preparation contained in the mold is still liquid and it needs to be transported from one surface to another, such as from the work surface to the oven, unless it has previously been installed on a supporting grill.

On the other hand, rigid molds made of several pieces which are dismountable from one another overcome the aforementioned drawbacks.

The invention thus concerns more particularly a dismountable mold of the type comprising:
a rigid wall, of general semicylindrical shape, open at its two lateral ends, with cross section having a general U shape and forming a trough open at its top portion;
two complementary transverse end walls so as to form with the semi-cylindrical wall a container open at its top portion and closed at its lateral transverse ends.

The different portions of the mold are assembled with one another, generally by fitting, snapping together, or by friction.

Many embodiments are already known for dismountable cake dough molds.

The dismountable nature provides a space saving, since the different respective constituent portions can generally be grouped together by type.

Even so, the dismountable nature causes three difficulties in particular.

First of all, the cleaning of the different elements, especially in the portion where they are joined together, may prove to be difficult.

Secondly, the sealing at the junction of the assembled pieces is not perfect. Yet it is essential, since one must of course avoid any leakage of dough from the mold.

Thirdly, the assembling of the pieces to one another needs to be done in such a way that the mold is rigid and cannot be deformed, in order to be handled by the user, on the one hand, and be placed on a flat surface, such as a work surface, or a grill or baking tray, on the other hand.

It will be appreciated that the imperatives of being dismountable, rigid, easily cleaned and finally sealed are contradictory.

The present invention aims to remedy these inconveniences and reconcile these conditions by proposing a cake mold which is easily dismountable, has satisfactory rigidity, and is able to be cleaned under the best of conditions without difficulty, while having optimal sealing properties.

For this purpose, according to the invention, the mold for food preparation, especially for cake dough or the like, of the type comprising:
a rigid semi-cylindrical wall forming a trough and open at its two ends, such as one with a section (especially a cross section) in the general shape of a U, a triangle, a trapezoid, a square, a rectangle, or some other shape, forming a trough;
two transverse end walls, complementary to the trough, so as to form with the latter a container open at its top portion and closed at its lateral transverse ends;

the semi-cylindrical wall and the transverse walls being associated in separable/detachable manner;

is characterized in that it comprises two means each able to cooperate with one of the end edges of the trough, each means on the one hand being associated with a flat rigid plate so as to thus form one of the transverse walls, and on the other hand comprising a peripheral groove able to receive, and cooperate with, the corresponding peripheral edge (rim) of the semi-cylindrical wall of trough shape, these means constituting means of sealing.

Thus, the assembly is composed of only three pieces: the trough on the one hand, and the two means of sealing, each one furthermore including a transverse wall, on the other hand.

The means of sealing of the invention thus fulfill the functions:
of removable or detachable assembly between the trough-shaped wall and each transverse wall,
of sealing, and
of rigidity.

The sealing means thus constitute, in combination, sealing means, means of removable assembly between the trough-shaped wall and each transverse wall, and means of rigidity, by forming each transverse wall.

Consequently, the mold of the invention results in a simple and rapid use and once the pieces have been assembled it forms a rigid block of guaranteed sealing.

The cross section of the trough is a U shape, for example, but it could have a different geometry, such as trapezoidal, triangular, square, rectangular, or another.

According to one preferred embodiment, each sealing means is comprised of a block having:
a flat portion surrounding at least the periphery of the rigid plate, preferably extending over the entirety of one surface of the rigid plate and covering its rim;
a portion opposite the flat portion, forming a peripheral bead, including said groove open in the general longitudinal direction of the trough, the groove being continuous over the entire periphery and having a geometrical line corresponding to the cross section of the trough.

According to one embodiment, the rigid plate is overmolded on said flat portion, the plate preferably having a grasping zone which extends beyond said flat portion of the sealing means.

According to one variant, said flat portion comprises a seat complementary to said flat plate in which the latter is able to be inserted, in a removable manner. In this case, the flat portion surrounds nearly all of the plate, and preferably the plate has a grasping zone which extends beyond said flat portion of the sealing means.

Advantageously, the sealing means are made of a flexible material to facilitate their association with the trough, and to guarantee a seal with it, said means thus hugging (perfectly) the edges and the mating surface with the trough.

Preferably, the sealing means are made of a plastic material such as silicone, or the like.

The rigid plate associated with the sealing means makes it possible to provide a rigid block for supporting the transverse walls of the mold, while making it possible to use a flexible material for the sealing means in order to guarantee the sealing, as mentioned above.

One variant might have been to make the block from a transverse wall consisting of one or more sealing materials with different portions in order to provide on the one hand the rigidity function for the portion facing the transverse opening of the trough, and on the other hand the flexibility function for the portion associated with the trough in the area of its cutoff and immediately proximal surfaces.

But the proposed embodiment of a single material and flexibility of the sealing means makes it possible to simplify the fabrication.

Advantageously, the mold and in particular each sealing means or each block has seating means, in the portion opposite the opening of the trough, so as to ensure the stability of the mold on a flat surface, once the two sealing means have been associated with the longitudinal trough, in particular the seating means protruding with respect to the bottom of the trough.

More precisely, the seating means comprise two feet or lugs on each block (on each sealing means), in the lower portion, opposite the upper open portion of the trough, and projecting with respect to the bottom of the trough.

The two sealing means (the two blocks) thus form seating means, feet, to set down the mold assembly.

The seating means of each sealing means have suitable shape and dimensions to provide them with rigidity or semi-rigidity, whereas the rest of the sealing means associated with the trough are flexible or relatively flexible.

The semi-cylindrical wall forming the trough, as well as the plate associated with the corresponding sealing means, are metallic, more particularly stainless steel. The aforementioned metallic portions making it possible to rigidify the mold may likewise be made of any rigid material, especially a rigid plastic such as one based on polyamide, or even a composite material, or are made of ceramic, or glass, for example.

In order to reinforce the rigidity of the cylindrical wall forming the trough, the latter has, on each of the two parallel longitudinal edges, a flange making an angle with the tangent to said edge (preferably a horizontal angle in the position of placement of the mold on a surface).

The present invention shall now be described with the aid of examples which are solely illustrative and in no way limiting of the scope of the invention, and based on the enclosed illustrations, in which:

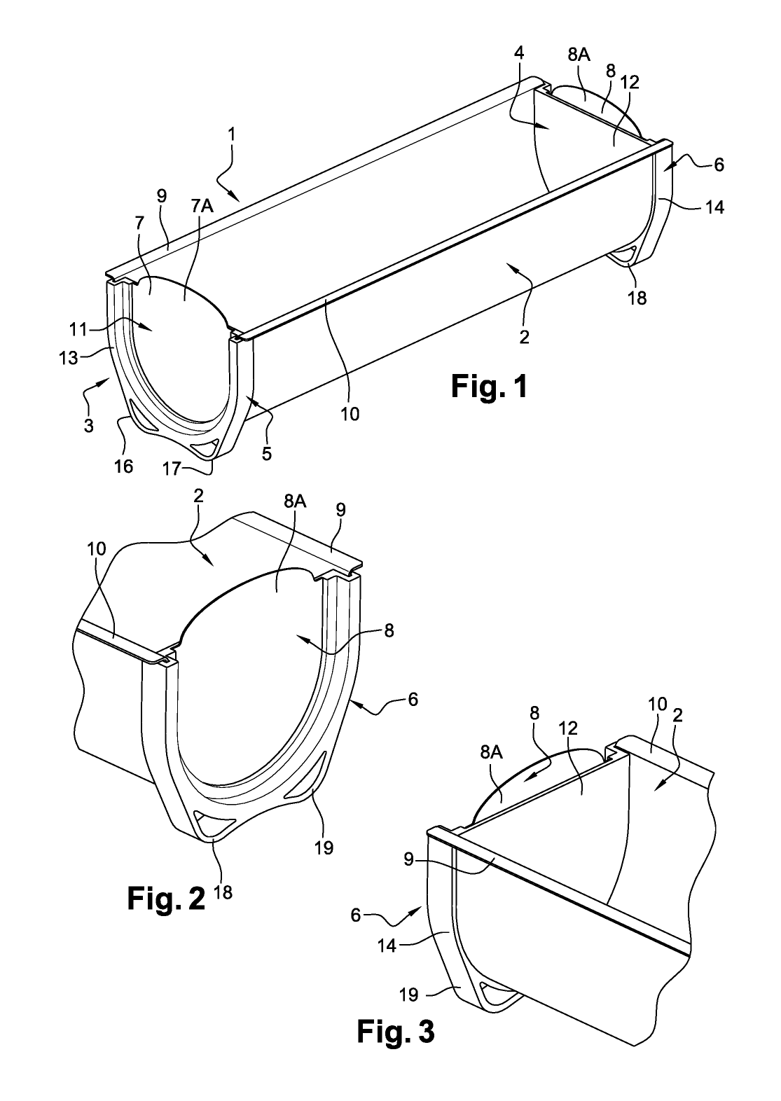

FIG. 1 shows the mold of the invention in slanting lateral perspective view;

FIG. 2 is a detail view, at larger scale, of a transverse wall and of one of the sealing means, at one end of the trough;

FIG. 3 shows the mold of FIG. 2 in perspective view, seen from the other side in the longitudinal direction of the trough;

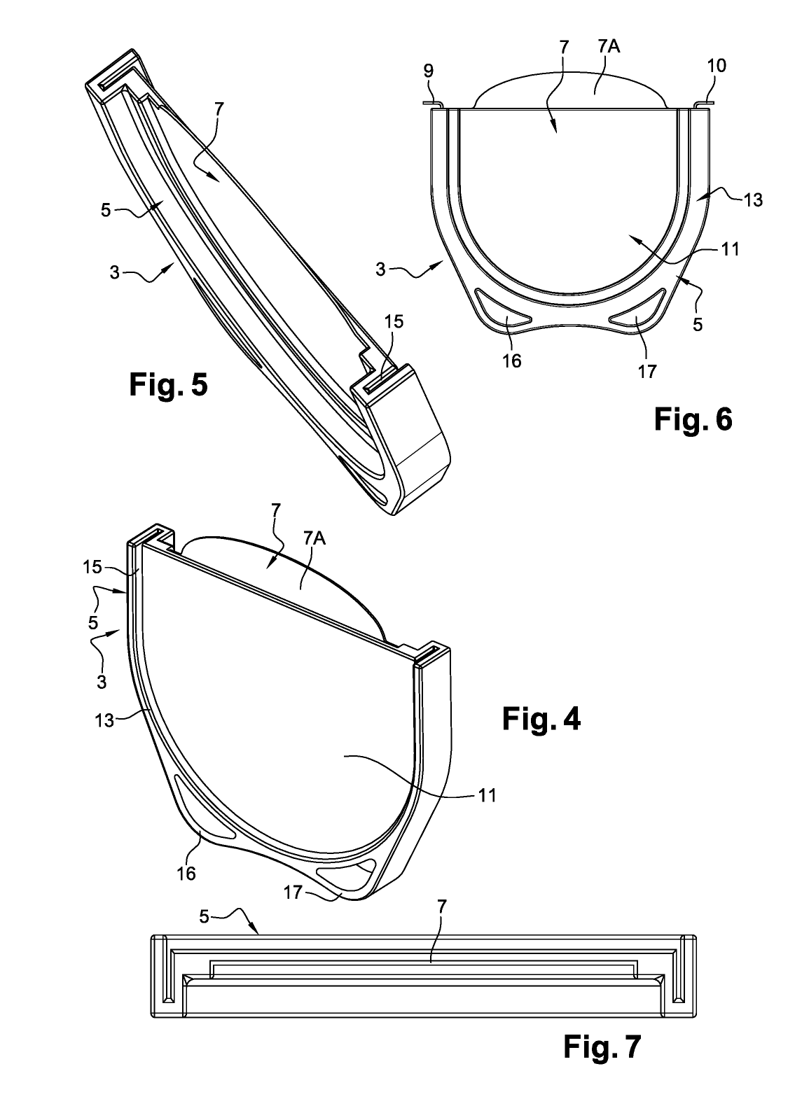

FIG. 4 is a front and top perspective view of one of the sealing means associated with a transverse wall;

FIG. 5 is a perspective top view of the assembly of FIG. 4;

FIG. 6 is a front view of the mold of FIG. 4;

FIG. 7 is a top view of the assembly of FIG. 4;

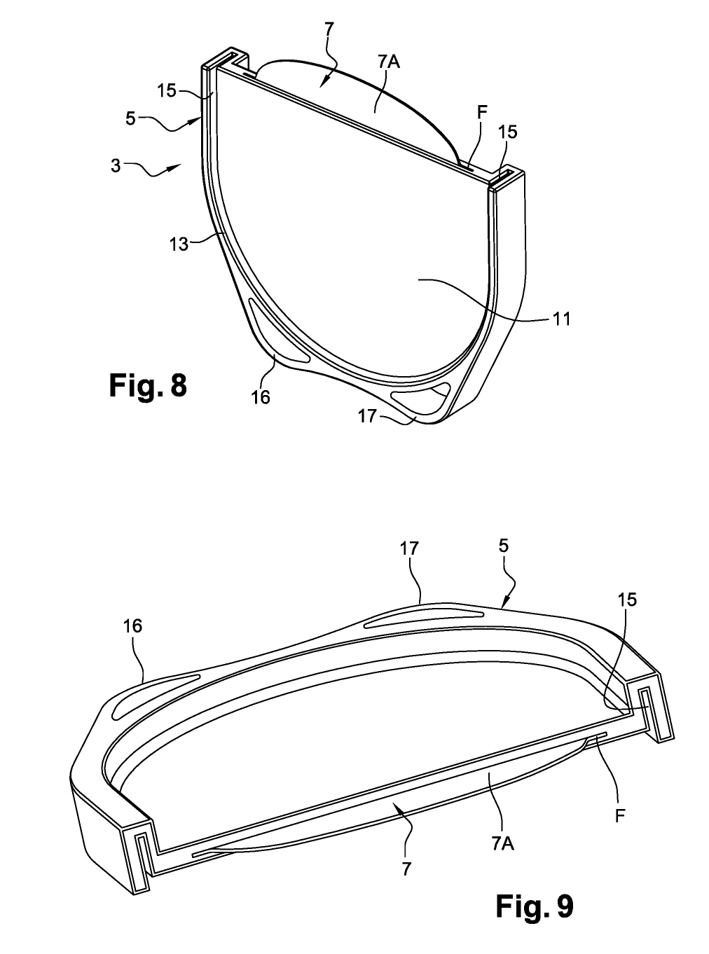

FIG. 8 is a variant of FIG. 4; and

FIG. 9 is a variant of FIG. 5, along a different angle of perspective.

In the following description, the term “height”, “width”, “depth”, the adjectives “horizontal”, “vertical”, “upper”, “lower”, “top” and “bottom” of an element are used in the context of a normal installation of the mold, that is, relative to a vertical notion with respect to a horizontal plane.

Reference shall now be made to FIG. 1 showing in perspective the mold 1 of the invention, and in the example shown, of elongated shape and constituting a log, loaf cake or brioche mold.

The mold 1 comprises:
a substantially semicylindrical wall 2, forming a trough, with a U-shaped cross section open at the top portion and open at its opposite distal transverse ends, the wall being formed by a bent or curved sheet or plate, preferably of stainless steel;
two transverse end walls 3 and 4, complementary to the two end edges of the trough; and
two sealing means 5 and 6, each cooperating with the peripheral end edges of the trough and associated with a flat plate 7, 8.

Each sealing means 5, 6 associated with the corresponding flat plate forms a transverse end wall 3, 4.

The semi-cylindrical wall 2 forming the trough comprises, on each of the parallel longitudinal edges, a horizontal flange 9, 10, which is horizontal in the position of placement of the mold on a surface, and making an angle with the tangent to said edge. These two folded flanges 9 and 10 reinforce the rigidity of the trough.

Each sealing means is formed by a block 5, 6 having:
a flat portion 11, 12 surrounding at least the periphery of the rigid plate 7, 8;
a portion forming a peripheral bead 13, 14 in the general shape of a U, substantially complementary to the U of the trough.

Each block is made of a plastic material such as silicone or the like.

The flat portion 11, 12 is solid and rigid. It forms a plate able to close the open transverse distal ends of the trough.

The flat portion 11, 12 is associated with the corresponding peripheral bead 13, 14 in the following preferred manner.

Each flat portion 11, 12 of each sealing means surrounds or is overmolded on the rigid flat plate 7, 8 so as to make a body with the flat portion.

As a variant, which is shown in FIGS. 8 and 9, each portion 11, 12 comprises a seat or slot referenced “F”, complementary to said flat plate in which the latter may be inserted, in a removable manner. In this case, the flat portion surrounds nearly all of the plate, on each side, except for an upper grasping zone which extends beyond the complementary seat provided in said flat portion.

Each wall 3, 4, in particular each flat rigid plate 7, 8, has a grasping zone 7A, 8A which extends beyond the flat portion 11, 12 of the sealing means, in the upper portion, that is, on the side with the U-shaped opening of each bead 13, 14.

The removable joining of the trough 2 and each sealing block 5, 6 is described below, with reference to FIGS. 4, 5 and 7.

Each bead 13, 14 includes a groove 15, open in the general longitudinal direction of the trough, the groove being continuous over the entire periphery of bead. The groove 15 is of shape and dimensions complementary to the peripheral transverse edge of the trough.

The peripheral transverse edge of the trough is thus engaged by friction in the groove 15, so as to be joined in detachable or removable manner, for the dismounting of the mold.

Advantageously, the block has seating means, in the portion opposite the opening of the trough, so as to ensure the stability of the mold on a flat surface, once the two blocks have been associated with the longitudinal trough.

Advantageously, the seating means are associated with the sealing means 5, 6.

Said seating means contain, for each bead, two feet or lugs 16, 17 (respectively 18, 19) on each block 5, 6, in the lower portion, opposite the upper portion of each block comprising the grasping means, and projecting with respect to the bottom of the trough.

The two blocks 5 and 6 thus form feet for setting down the mold on a flat surface or an oven grill.

The shape of the seating means along with the fact that the material has sufficient thickness provides a rigidity for these seating means, despite the flexibility of the material used for the assembly of the sealing means.

The body of the seating means 16 and 17 is openwork, as illustrated in the figures, to save on manufacturing material.

As dimensional examples which are in no way limiting, some of the dimensions are as follows:
length of the trough: on the order of 500 or 300 mm;
width of the trough: on the order of 100 mm;
height of the trough: on the order of 70 mm;
height of a block from the distal end of the seating means to the upper portion of the grasping zone: on the order of 85 to 90 mm;
height of the sealing means: on the order of 75 to 80 mm;
thickness of the sealing means: on the order of 20 mm.

1-10. (canceled)

11. A mold for food preparation, comprising:
a rigid semi-cylindrical wall forming a trough and open at its two ends;
two transverse end walls, complementary to the trough, to form with the trough a container open at its top portion and closed at its lateral transverse ends;
the rigid semi-cylindrical wall and the transverse end walls are associated with each other in a detachable manner;
two sealers, each sealer configured to cooperate with one of end edges of the trough, each sealer is associated with a flat rigid plate to form, with a corresponding flat rigid plate, one of the transverse end walls, and each sealer comprises a peripheral groove configured to receive and cooperate with a corresponding peripheral edge of the rigid semi-cylindrical wall of a trough shape.

12. The mold as claimed in claim 11 to prepare a cake dough.

13. The mold as claimed in claim 11, wherein the two sealers, in combination, are configured to provide removable assembly of the trough-shaped semi-cylindrical wall to each transverse end wall, and wherein said each sealer forms said each transverse end wall to provide rigidity.

14. The mold as claimed in claim 11, wherein a cross section of the trough is a U shape, trapezoidal, triangular, square, or rectangular.

15. The mold as claimed in claim 11, wherein each sealer comprises a block comprising a flat portion surrounding at least a periphery of the flat rigid plate; and a portion opposite the flat portion, forming a peripheral bead, including the peripheral groove open in a longitudinal direction of the trough, the peripheral groove is continuous over entire periphery of the trough and comprises a geometrical line corresponding to a cross section of the trough.

16. The mold as claimed in claim 15, wherein the flat portion extends over an entirety of one surface of the flat rigid plate and covering a rim of the flat rigid plate.

17. The mold as claimed in claim 15, wherein the flat rigid plate is over-molded on the flat portion.

18. The mold as claimed in claim 17, wherein the flat rigid plate comprises a grasping zone extending beyond the flat portion of said each sealer.

19. The mold as claimed in claim 17, wherein the flat portion comprises a seat complementary to the flat rigid plate, the flat rigid plate is removably insertable into the seat such that the flat portion surrounds nearly all of the flat rigid plate.

20. The mold as claimed in claim 19, wherein the flat rigid plate comprises a grasping zone extending beyond the flat portion of said each sealer.

21. The mold as claimed in claim 13, wherein the two sealers are made of a flexible material.

22. The mold as claimed in claim 21, wherein the flexible material is silicone.

23. The mold as claimed in claim 15, wherein each sealer comprises a seat in a portion opposite an open end of the trough, to ensure a stability of the mold on a flat surface once the two sealers have been associated with the trough.

24. the mold as claimed in claim 23, wherein the seat protrudes with respect to a bottom of the trough.

25. The mold as claimed in claim 11, wherein the rigid semi-cylindrical wall forming the trough and the flat rigid plate associated with a corresponding sealer are metallic, preferably stainless steel.

26. The mold as claimed in claim 11, wherein the rigid semi-cylindrical wall forming the trough and the flat rigid plate associated with a corresponding sealer are made of glass, ceramic, rigid plastic, preferably a polyamide based plastic, or composite material.

27. The mold as claimed in claim 11, wherein the rigid semi-cylindrical wall forming the trough comprises, on each of two parallel longitudinal edges, a flange making an angle with a tangent to said each parallel longitudinal edge.
